(19) United States
(12) Patent Application Publication
(10) Pub. No.: US 2020/0222273 A1
(43) Pub. Date: Jul. 16, 2020

(54) TOPICAL MASSAGE DEVICE, AND CHAIR AND MAT PROVIDED WITH TOPICAL MASSAGE DEVICE

(71) Applicant: KAMSAHAN CO.,LTD., Gimhae-Si (KR)

(72) Inventor: Tae Yeon PARK, Seoul (KR)

(73) Assignee: KAMSAHAN CO.,LTD., Gimhae-Si (KR)

(21) Appl. No.: 16/651,274

(22) PCT Filed: Nov. 13, 2018
(86) PCT No.: PCT/KR2018/013842

§ 371 Date: Mar. 26, 2020

(30) Foreign Application Priority Data
Nov. 15, 2017 (KR) 10-2017-0152551
Jul. 16, 2018 (KR) 10-2018-0082595
Sep. 20, 2018 (KR) 10-2018-0112665

(51) Int. Cl. A61H 23/02; A61H 39/04

(52) U.S. Cl. CPC A61H 23/02; A61H 39/04; A61H 2205/086; A61H 2201/1623; A61H 2205/085; A61H 2201/0149

(57) ABSTRACT

Disclosed are a topical massage device capable of vibrating and massaging a perineal region and an anal region at the same time, and a massage chair and mat equipped with the same. The topical massage device includes a base plate (12); a plurality of support members (170) engaged to an upper portion of the base plate (12), and made of an elastic material; a vibration plate (160) fixed to an upper portion of the respective support members (170); a massage pad (110) installed to an upper portion of the vibration plate (160) so as to move in forward and rearward directions; and a vibrator (120) engaged to the vibration plate (160) to vibrate the massage pad (110). The topical massage device can be installed to the seating mat or various types of chairs, so that anyone can effectively receive the massage, regardless of the body size, thereby preventing various diseases of a topical region and relieving the stress.

### TECHNICAL FIELD

The present invention relates to a topical massage device, and a chair and a mat, respectively, provided with the same, and more particularly, to a topical massage device capable of vibrating and massaging a perineal region and an anal region of a user at the same time, and a massage chair and a mat, respectively, provided with the same.

### BACKGROUND ART

Recently, modern people suffer from various diseases of prostate and anus, which cause great inconvenience to daily life. One example of technologies for curing and preventing these diseases is disclosed in Korean Utility Model No. 20-0413567, entitled ‘Massage apparatus of vibration type for prostate’, in which an upper portion of a seat is provided at a center portion thereof with a vibration unit for vibrating and massaging an anal region of a user.

Another example is disclosed in Korean Patent Publication No. 10-0830027, entitled ‘Massage mat including vibrating and heating devices for perineal region’, in which the massage mat is equipped with a heating member and a vibration motor to build up promotion of health by raising a core temperature which stimulates circulation of blood, and relieves stress.

However, the above patents have a problem in that since the position of the vibrating protrusion is fixed, it is hard to simultaneously massage the perineal region and anal region of the user at the exact positions.

### PRIOR ART DOCUMENTS

### Patent Literatures

Patent Document 1: Korean Utility Model No. 20-0413567 (Apr. 7, 2006)

Patent Document 2: Korean Patent Publication No. 10-0830027 (May 8, 2008)

### DISCLOSURE

### Technical Problem

Accordingly, the invention has been made in view of the above-mentioned problems occurring in the related art, and one object of the invention is to provide a topical massage device capable of simultaneously vibrating and massaging a perineal region and anal region of a user, and optionally adjusting a position of a vibrating massage pad.

Another object of the invention is to provide a massage chair including massage rollers for massaging a back and waist of a user by vibration and press, a footrest for massaging a foot and calf of the user by pneumatic pressure, and a topical massage device, thereby allowing the user to get a topical massage, as well as massaging upper and lower bodies.

Also, further object of the invention is to provide a massage seating mat provided with a topical massage device at a center thereof, so that the massage seating mat is put on a general chair or a floor, and then a user gets a massage conveniently.

### Technical Solution

To accomplish the above-mentioned objects, according to one aspect of the invention, there is provided a topical massage device including: a base plate 12; a plurality of support members 170 engaged to an upper portion of the base plate 12, and made of an elastic material; a vibration plate 160 fixed to an upper portion of the respective support members 170; a massage pad 110 installed to an upper portion of the vibration plate 160 so as to move in forward and rearward directions; and a vibrator 120 engaged to the vibration plate 160 to vibrate the massage pad 110.

The topical massage device further includes transfer screw support portions 134 provided to front and rear portions of the vibration plate 160; a transfer screw 133 rotatably installed to the transfer screw support portions 134 at both ends thereof; a transfer screw rotor 135 engaged to one end of the transfer screw 133 to rotate the transfer screw 133; and a transfer bar 136 provided with at a lower portion thereof with a transfer nut 132 which is threadedly engaged to the transfer screw 133, with the massage pad 110 being detachably engaged to an upper portion of the transfer bar, so that a position of the massage pad 110 is adjusted by rotating the transfer screw rotor 135.

Two transfer screws 133 are installed to front and rear portions of the vibration plate 160, and both ends of the respective transfer screws are supported by the transfer screw support portions 134 so as to rotate independently. A transfer screw rotor 135 is provided to one end of the respective transfer screws 133 to rotate the transfer screw 133. The massage pad 110 includes an anterior massage member 111 with a nut 111a provided on a bottom surface thereof and a posterior massage member 112 with a nut 112a provided on a bottom surface thereof, with the anterior massage member and the posterior massage member being separately provided. The anterior massage member 111 and the posterior massage member 112 are engaged to an upper portion of a transfer bar 136 with a transfer screw support portion 134 formed at one side thereof. Lifting screws 141 pass rotatably through the respective transfer bars 136, and are engaged to the nuts 111a and 112a, respectively.

Transfer screws 133 are installed to front and rear portions of the vibration plate 160, and one end of the transfer screw 133 has a transfer bar 136. The massage pad 110 includes an anterior massage member 111 with a nut 111a provided on a bottom surface thereof and a posterior massage member 112 with a nut 112a provided on a bottom surface thereof, with the anterior massage member and the posterior massage member being separately provided. Lifting screws 141 pass rotatably through the respective transfer bars 136, and are engaged to the nuts 111a and 112a, respectively. An adjustment nut 146 for moving the respective transfer bars 136 in forward and rearward directions is engaged to the transfer screw 133.

The support member 170 has a cylindrical support rubber 172 with upper and lower portions engaged to fastening screws 171 to transmit soft vibration to the massage pad 110. The fastening screw 171 has a screw head 171a formed on one end of the fastening screw, and a recessed portion 171b formed on an engaging surface of the screw head 171a, thereby increasing an engaging force between the upper and lower fastening screws 171 and the support rubber 172.

According to another aspect of the invention, there is provided a chair equipped with the topical massage device, wherein the topical massage device 100 is installed to a center portion of a seating unit 20, and includes a massage pad 110 which protrudes upwardly from the seating unit 20 to intensively massage the perineal region and an anal region of the user by vibrating the massage pad.

A backrest unit 10 is provided to one side of the seating unit 20 to support a back of the user, and the backrest unit 10 includes an upper body stretching member 50 which has a hand lever 51 operated in a vertical direction by a driving force, so that when the hand lever 51 is moved up by both hands, the user can relief upper muscles and ligaments.

According to the other aspect of the invention, there is provided a seating mat equipped with the topical massage device, wherein the topical massage device 100 is installed to a center portion of a seating unit 20, and includes a massage pad 110 which protrudes upwardly from the seating mat to intensively massage the perineal region and anal region of the user by vibration of the massage pad.

### Advantageous Effects

With the above configuration of the invention, the perineal region and anal region of the user can be simultaneously massaged by the topical massage device, thereby preventing various diseases of a topical region and relieving the stress.

Also, since the position and height of the vibrating massage pad is easily adjusted, anyone can effectively receive the massage at the optimum position, regardless of the body size.

### DESCRIPTION OF DRAWINGS

FIG. 1 is a perspective view illustrating a massage chair including a topical massage device according to one embodiment of the invention;

FIG. 2 is an exploded perspective view illustrating the detailed configuration of the topical massage device according to one embodiment of the invention;

FIG. 3 is a side cross-sectional view illustrating an assembled state of a massage chair and the topical massage device according to one embodiment of the invention;

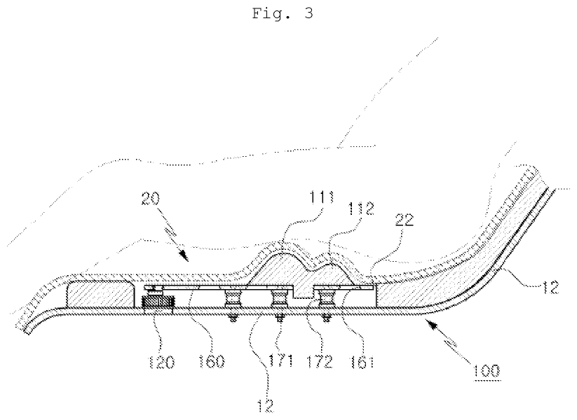

FIG. 4 is a cross-sectional view illustrating the configuration of a support member for the topical massage device according to one embodiment of the invention;

FIG. 5 is a perspective view illustrating a state in which the topical massage device is provided in a massage chair having a stretching function;

FIG. 6 is a perspective view illustrating a topical massage device according to another embodiment of the invention;

FIG. 7 is a cross-sectional view illustrating the installed state of the topical massage device in FIG. 6;

FIG. 8 is a perspective view illustrating a topical massage device including a separate massage pad;

FIG. 9 is a perspective view illustrating a positioning method of the massage pad, when seen from a bottom;

FIG. 10 are a perspective view and a cross-sectional view illustrating a method for independently positioning an anterior massage member and a posterior massage member according to another embodiment of the invention;

FIG. 11 is a view illustrating a height adjusting member of the anterior and posterior massage members in the separate massage pad;

FIG. 12 is a perspective view illustrating a topical massage device including the separate massage pad;

FIG. 13 is an exploded perspective view illustrating the topical massage device including the separate massage pad; and

FIG. 14 is a perspective view illustrating a general chair including the topical massage device according to one embodiment of the invention.

### MODE FOR INVENTION

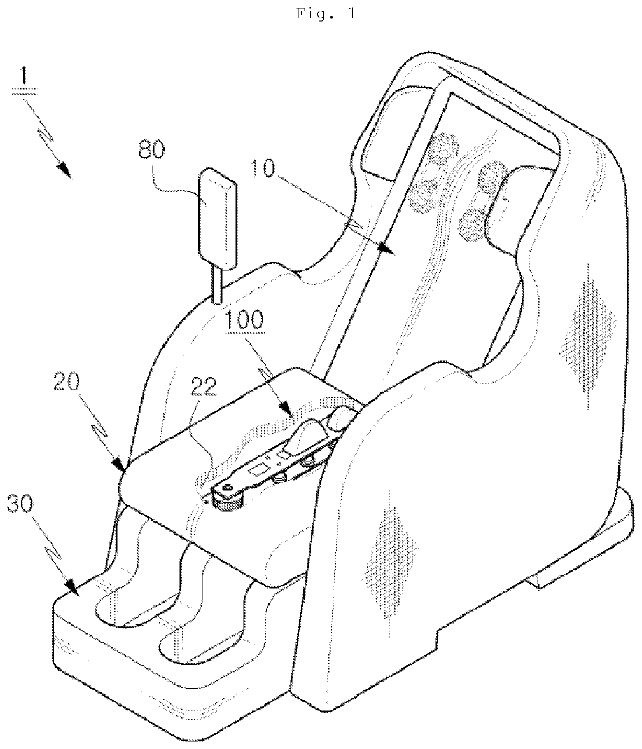

Hereinafter, preferred embodiments of the invention will be described in detail with reference to the accompanying drawings. FIG. 1 is a perspective view illustrating a massage chair including a topical massage device according to one embodiment of the invention. As illustrated in FIG. 1, the massage chair includes a backrest unit 10 with a pair of massage rollers 40 installed to left and right sides and being movable in a vertical direction, a seating unit 20 for supporting a user sitting on the chair, and a footrest unit 30 having an air tube which is contracted and expanded to massage feet and calves of the user which are put in the air tube, and the backrest unit 10 and the seating unit 20 are fixed to and supported by left and right frames of the massage chair.

The invention is characterized in that a topical massage device 100 is installed to a center portion of the seating unit 20 to provide a massage function to a topical region of a body, for example, an anal region and an anal region.

The seating unit 20 supports hips of the user sitting on the chair, and has at the center portion an installation groove 22 for receiving the topical massage device 100 so that only a massage pad 110 protruding from a seating plate comes into direct contact with the topical region.

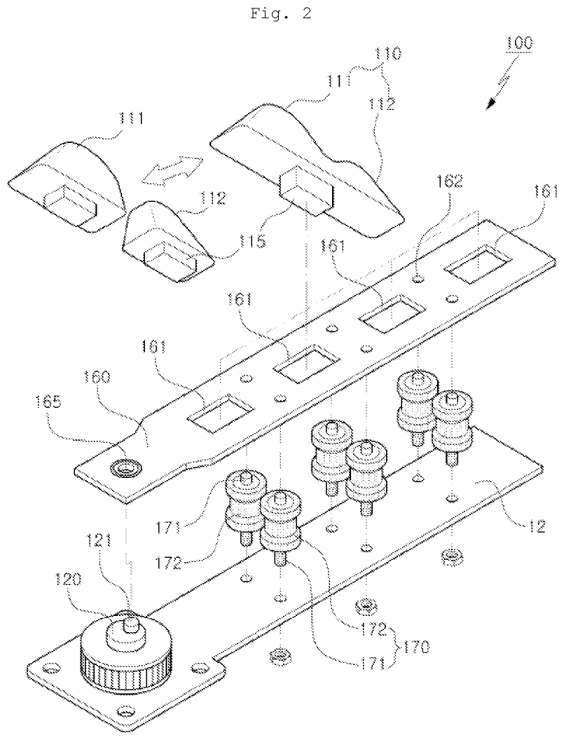

FIG. 2 is an exploded perspective view illustrating the detailed configuration of the topical massage device 100 according to the first embodiment of the invention. The topical massage device 100 includes a plurality of support members 170 engaged to a base plate 12 which is provided in the seating unit 20, and protruding upwardly from the base plate at a certain height, a vibration plate 160 fixed to an upper portion of the support member 170 and provided with a plurality of massage pad engaging grooves 161, and a massage pad 110 made of an elastic resin and engaged to the engaging groove 161.

The vibration plate 160 is provided with the plurality of massage pad engaging grooves 161 for receiving an engaging protrusion 115 formed on a bottom surface of the massage pad 100 at a proper position, and an engaging position of the massage pad engaging groove 161 and the engaging protrusion 115 may be varied according to a position of the wanted topical region of the user.

The base plate 12 and the respective support members 170 are engaged by inserting a fastening screw 171, which is formed on a bottom surface of the support member, into a hole formed in the base plate 12 and then fastening a nut to the fastening screw 171.

The massage pad 110 has an anterior massage member 111 and a posterior massage member 112 which protrude from front and rear portions in a curved shape, like a camel's back. The anterior massage member 111 is formed in a relatively large size to massage the perineal region of the user, while the posterior massage member 112 is formed in a relatively small size to massage the anal sphincter.

A vibrator 120 having an eccentric motor is installed to the base plate 12 or the inner support frame of the seating unit 20, and an eccentric shaft of the vibrator 120 is coupled to an engaging groove 165 formed in the vibration plate 160. The vibrator 120 employs the eccentric motor, but the vibrator may employ various types, such as an ultrasonic vibrator or an electromagnetic vibrator.

The support member 170 has a cylindrical support rubber 172 with upper and lower portions engaged to the fastening screws 171.

The support rubber 172 elastically supports the weight of the user, who sits on the chair, on the base plate 12 in the state of being spaced apart from the vibration plate 160 vibrated by the vibrator 120 at a certain height, and transfers soft vibration to the topical region through the elasticity of the rubber.

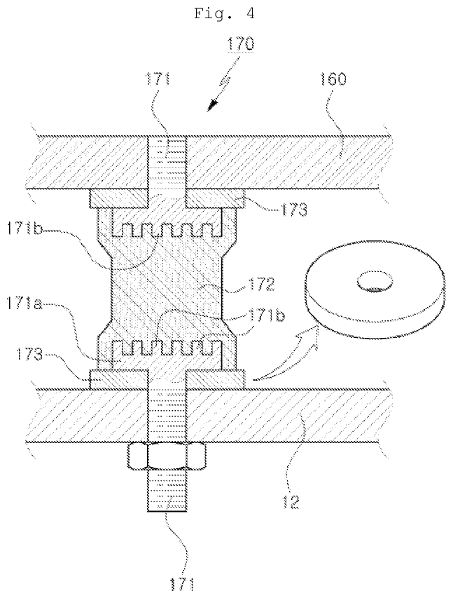

FIG. 4 is a cross-sectional view illustrating the configuration of the support member for the topical massage device according to one embodiment of the invention. In order to increase the engaging force between the upper and lower fastening screws 171 and the support rubber 172, the fastening screw has a screw head 171a integrally formed on one end of the fastening screw, and a recessed portion 171b formed on an engaging surface of the screw head. A rubber washer 173 is interposed between the screw head 171a and the vibration plate 160 and between the screw head 171a and the base plate 12 so as to reduce noise generated between the vibration plate 160 and the base plate 12 which are engaged to the upper and lower portions of the support member.

A vibration-proof pad may be provided to absorb the noise and vibration generated from the vibrator and thus isolate the noise and the vibration from the outside.

The topical massage device 100 according to the embodiment of the invention is installed to the seating plate of the massage chair 1, and if the power is supplied to the vibrator 120, the vibration plate 160 coupled to the shaft of the vibrator and the massage pad 110 engaged to the upper portion of the vibration plate are softly vibrated at high speed to provide the effective vibration massage to the perineal region and the anal region.

The vibration generated from the vibrator 120 is transmitted to the vibration plate 160, and the support members 170 coupled to the vibration plate 160 buffer the vibration, while reducing the noise, so that the soft vibration is transmitted to the massage pad 110 which comes into direct contact with the topical region.

Also, since the support rubber 172 absorbs the vibration generated from the vibration plate 160, the vibration plate provides stimulation to the topical region of the body in the upper portion of the chair, while vibration energy is not transmitted from the vibration plate to the base plate 12, so that the massage chair equipped with the topical massage device 100 is not wobbled to maintain the stable state.

In the case where the topical massage device is installed to the massage chair, the waist and back of the user is massaged by the massage rollers 40 operating in the backrest unit 10, and the topical region gets the vibration massage, thereby preventing and curing the disease of the prostate, stimulating circulation of blood, and relieving the stress.

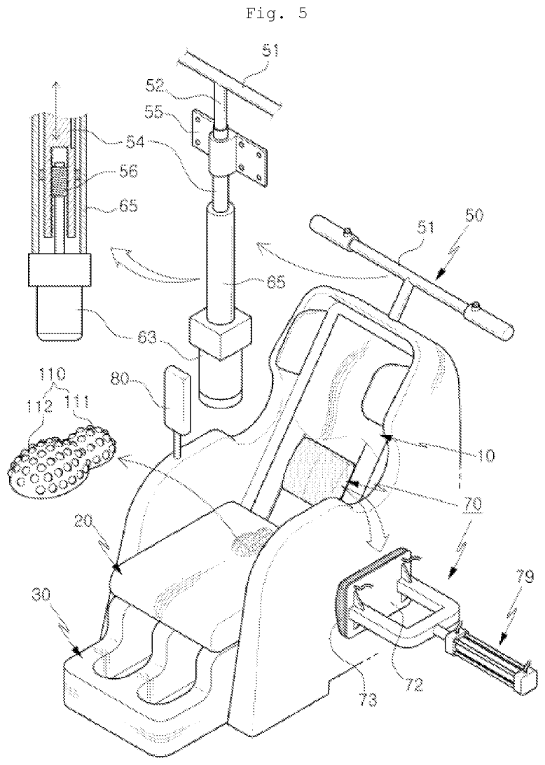

FIG. 5 is a perspective view illustrating the state in which the topical massage device is provided in a massage chair having a stretching function. The surfaces of the massage rollers provided in the backrest unit 10 and the surface of the massage pad 110 of the seating unit 20 are provided with a plurality of acupressure bosses to provide a stimulating massage effect. In particular, the massage pad 110 of the topical massage device 100 may be provided on the surface thereof with various sizes of acupressure balls at some positions to improve the acupressure massage effect. It will be readily apparent to those skilled in the art that the surface of the curved protrusion may be provided with corrugated protrusions, in addition to the protrusion of the ball shape.

Referring to FIG. 5, the backrest unit 10 includes an upper body stretching member 50. The upper body stretching member 50 has a hand lever 51 installed to a rear portion of the backrest unit 10 of the massage chair 1 and operated in a vertical direction by a driving force. When the hand lever 51 is moved up by both hands, the user can relief upper muscles and ligaments through stretching exercise.

The upper body stretching member 50 has a lever lifting motor 63, a stationary tube 65 fixed to an upper portion of the lever lifting motor 63, a lifting plunger 54 moved up and down by rotation of a screw 56 which is engaged to a driving shaft of the lever lifting motor 63, and a vertical supporter 52 engaged to an upper portion of the lifting plunger 54 at the center of the hand lever 51. Accordingly, the hand lever 51 is moved up or down by forward or reverse rotation of the lever lifting motor 63.

The lower portion of the backrest unit 10 of the massage chair has a lumbar stretching member 70 having a lumbar supporter 72 which is connected to an actuator 79 using a cylinder or an electric motor and moved up and down by the actuator, and a cushion 73 which is attached to the lumbar supporter 72.

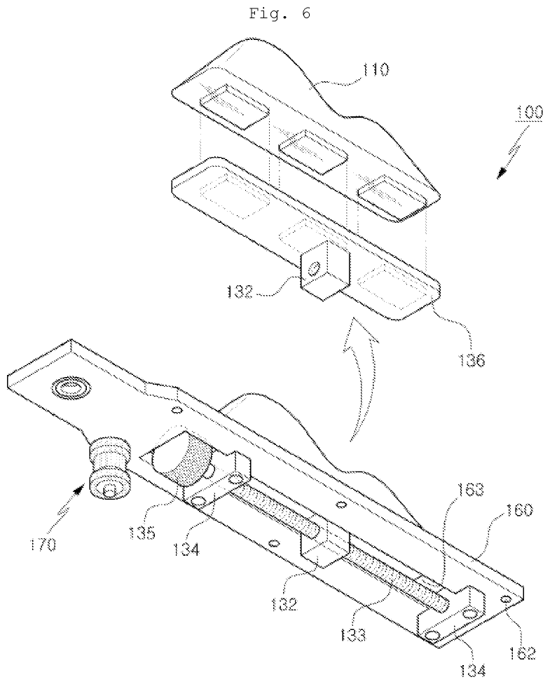

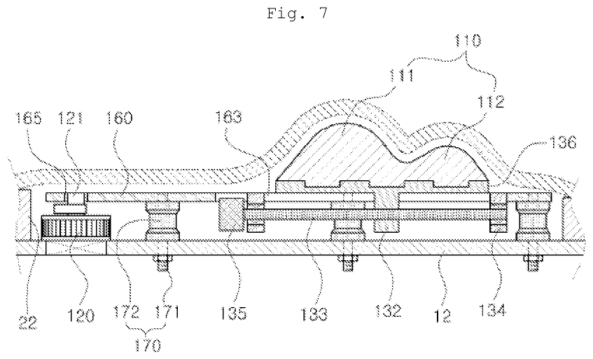

FIGS. 6 and 7 show the configuration for adjusting the position of the massage pad 110 in forward and rearward directions in the topical massage device 100.

The topical massage device 100 further includes an elongated hole 163 formed in the center portion of the vibration plate 160 in a longitudinal direction, and a transfer screw 133 with both ends being rotatably installed to a transfer screw support portion 134 on a bottom surface of the vibration plate.

The massage pad 110 has a transfer nut 132 protruding downwardly from a bottom surface of the massage pad, and the transfer nut 132 passes through the elongated hole 163, and is engaged to the transfer screw 133. A transfer screw rotor 135 is engaged to one end of the transfer screw 133 to manually or automatically rotate the transfer screw.

The transfer screw rotor 135 may be rotated by a hand to adjust the position of the massage pad 110. Preferably, the transfer screw rotor 135 is connected to a motor with an encoder, so that the user can operate a remote controller 80 or a control panel to easily adjust the position of the massage pad by remote control. Similarly, the vibration intensity or rotating speed of the vibrator 120 can be adjusted by the controller 80 or the control panel thereby to control the massage intensity.

The user can replace the massage pad 110 by one of a different type or material, if required. To this end, a transfer bar 136 is engaged to the upper portion of the transfer nut 132, and the massage pad 110 is coupled to the transfer bar. The bottom surface of the massage pad and the top surface of the transfer bar 136 are provided with an engaging protrusion and an engaging groove or magnets to firmly engage each other.

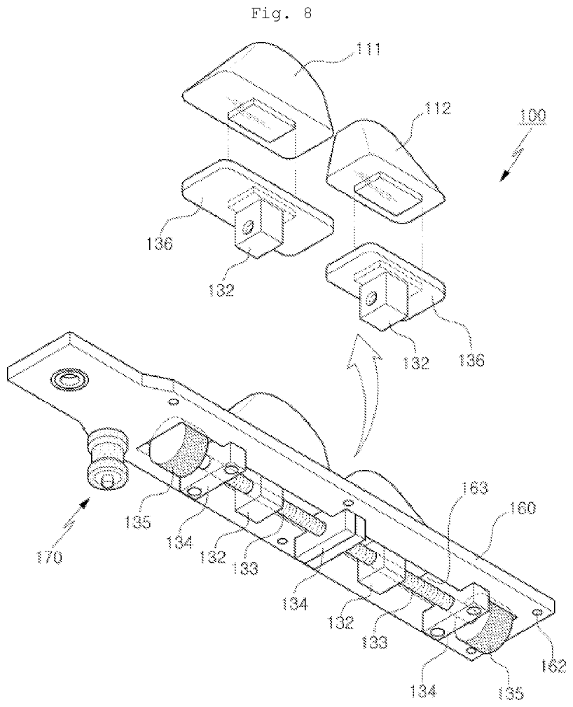

Since everybody has different positions of the perineal region and the anus, as well as a height, the anterior massage member 111 and the posterior massage member 112 are separately provided. The configuration capable of separately adjusting the positions is shown in FIGS. 8 to 12.

Referring to FIG. 8, two transfer screws 133 are separately and rotatably installed to the transfer screw support portion 134 at front and rear portions on the bottom surface of the vibration plate 160 with the elongated hole 163. The transfer screw rotor 135 is coupled to each end of the transfer screws 133.

Specifically, the massage pad 110 has the anterior massage member 111 and the posterior massage member 112 which are separately installed, and the bottom surfaces of the anterior and posterior massage members 111 and 112 are provided with the transfer nut 132, respectively. After the respective transfer nuts 132 passes through the elongated hole 163 of the vibration plate 160, and is engaged to the front and rear transfer screws 133.

If the transfer screws 133 positioned at the front and rear sides are independently rotated, the position of the anterior massage member 111 and the position of the posterior massage member 112 are separately adjusted, so that the user can get a proper massage from the anterior and posterior massage members installed at the optimum positions according to the type of his or her body.

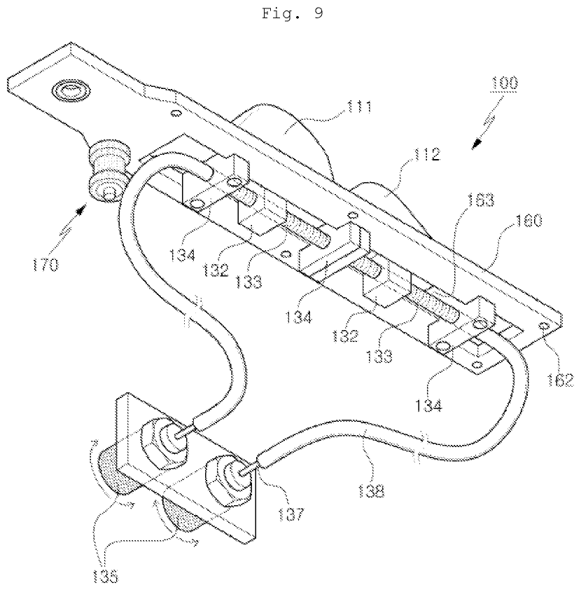

If the transfer screw rotor 135 is installed to an arm rest of the massage chair 1, the user can easily adjust the positions of the anterior and posterior massage members in a sitting posture. As illustrated in FIG. 9, a cable 137 which is a non-linear power transmission medium is connected between the transfer screw rotor 135 and the transfer screw 133 in a state in which the cable 137 is enclosed by a protective tube 138, so that the user can accurately adjust the positions of the anterior and posterior massage members 111 and 112 by remote control.

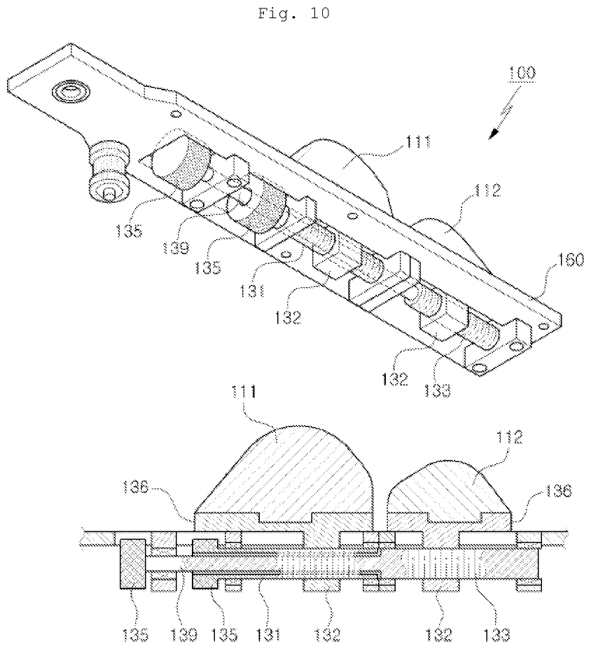

FIG. 10 are a perspective view and a cross-sectional view illustrating a method for independently positioning the anterior massage member 111 and the posterior massage member 112 according to another embodiment of the invention.

One transfer nut 132 provided to the bottom surface of the anterior massage member 111 and the other transfer nut 132 provided to the bottom surface of the posterior massage member 112 are inserted into the elongated hole 163 of the vibration plate 160. The one transfer nut 132 is threadedly engaged to a hollow sleeve threaded tube 131 with a transfer screw rotor 135 coupled to one end, and the other transfer nut 132 is threadedly engaged to a transfer screw 133 provided to one end of a coupling shaft 139 which is positioned in the sleeve threaded tube 131 and is able to freely rotate therein. When the transfer screw rotor 135 provided to the other end of the coupling shaft 139 is rotated, the positions of the anterior and posterior massage members are adjusted.

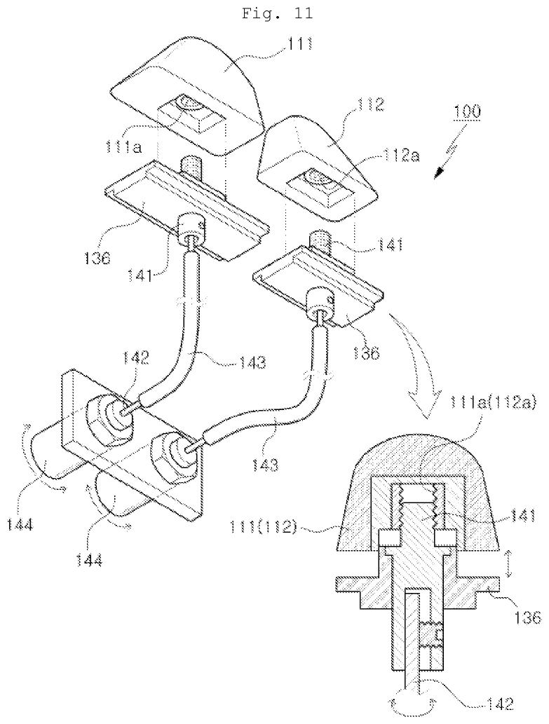

As described above, the position of the anterior massage member 111 and the position of the posterior massage member 112 can be separately adjusted, and as illustrated in FIG. 11, the user can adjust each height of the anterior and posterior massage members 111 and 112.

The bottom surfaces of the separated anterior and posterior massage members 111 and 112 are provided with nuts 111a and 112a, respectively, and a lifting screw 141 is rotatably installed to the transfer bars 136 which are engaged to the anterior and the posterior massage members 111 and 112, and is engaged to the respective nuts 111a and 112a.

One end of a cable 142 which is a non-linear power transmission medium is fixed to the lower portion of the lifting screw 141, and the other end is engaged to a rotational adjustment knob 144. When the knob 144 is rotated, the lifting screw 141 is rotated, and thus the anterior massage member 111 and the posterior massage member 112 are independently moved up and down, so that the user can conveniently adjust the positions of the anterior and posterior massage members 111 and 112 according to the body feature of the user.

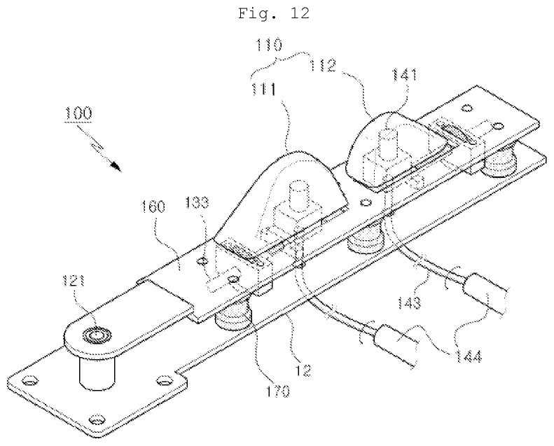

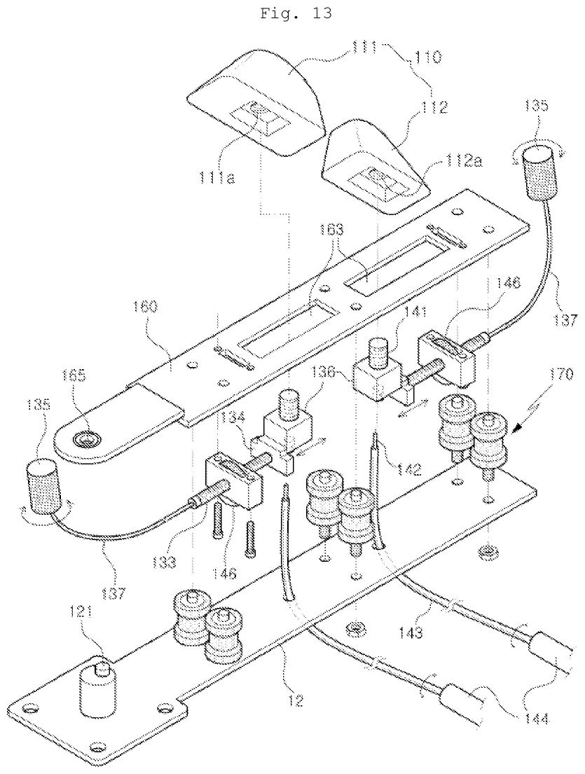

FIGS. 12 and 13 show the configuration for adjusting the horizontal positions and height of the massage pad in the topical massage device according to another embodiment of the invention.

A transfer screw 133 with a transfer bar 136 formed at one end is provided at the front and rear ends of the vibration plate 160, and an adjustment nut 146 for moving the transfer bar 136 in a horizontal direction is engaged to the transfer screw 133.

The transfer bar 136 is guided along the elongated hole 163 formed in the center portion of the vibration plate 160 in a longitudinal direction, and is moved back and forth by the rotation of the adjustment nut 146. The lifting screw 141 rotatably passes through the center of the respective transfer bars 136, and a lower portion of the lifting screw 141 is connected to the knob 144 for rotating the lifting screw 141 by the cable 142.

The bottom surfaces of the separated anterior and posterior massage members 111 and 112 are provided with nuts 111a and 112a, and the nuts 111a and 112a are fastened to the lifting screw 141 on the transfer bar 136. The heights of the anterior and posterior massage members 111 and 112 are separately adjusted by rotating the knob 144, and the positions thereof are adjusted in the horizontal direction by rotating the adjustment nut 146.

In order to accurately adjust the positions of the anterior and posterior massage members 111 and 112 by remote control, the respective transfer screw 133 is supported by the transfer screw support portion 134 so as to be independently rotated, while the adjustment nut 146 is fixed not to rotate. One end of the respective transfer screws 133 is connected to the transfer screw rotor 135 by the cable 137.

It will be readily apparent to those skilled in the art that the anterior massage member 111 or the posterior massage member 112 may be moved up and down by a cylinder unit or an electric motor.

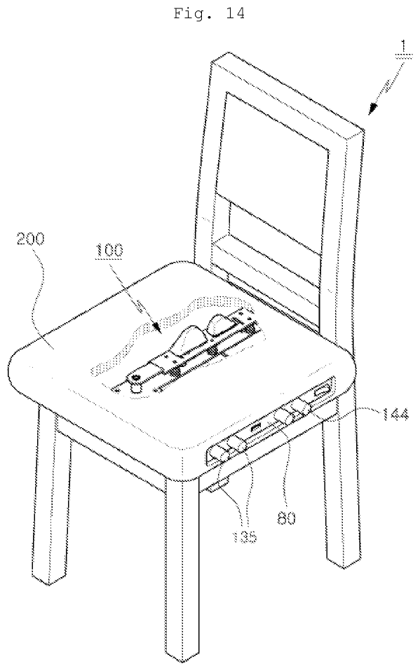

The topical massage device is integrally provided in the seating unit 20 of the massage chair 1 described above, but as illustrated in FIG. 14, a seating mat 200 equipped with the topical massage device 100 at a center thereof may be put on a general chair or a floor so that the user receives the massage.

When the user sits on the seating mat 200, his or her hips are supported by the upper plate of the seating mat, only the massage pad 110 which comes into contact with the topical region protrudes upwardly from the seating mat 200. In this instance, one side of the seating mat 200 is provided with a controller 80 for controlling a position and height of the massage pad 110 and turning on or off a power.

The configuration of the invention provides the topical massage device which can be installed to the seating mat or various types of chairs, so that anyone can effectively receive the massage, regardless of the body size, thereby preventing various diseases of a topical region, and relieving the stress.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

### BRIEF DESCRIPTION OF REFERENCE NUMERALS

1: Massage chair
200: Seating mat
10: Backrest unit
12: Base plate
20: Seating unit
22: Installation groove
30: Footrest unit
50: Upper body stretching unit
51: Hand lever
52: Vertical supporter
53: Shaft support
54: Lifting plunger
55: Installation plate
56: Screw
63: Lever lifting motor
65: Stationary tube
70: Lumbar stretching member
72: Lumbar supporter
73: Cushion
79: Actuator
80: Controller
100: Topical massage device
110: Massage pad
111: Anterior massage member
112: Posterior massage member
115: Engaging protrusion
120: Vibrator
121: Eccentric shaft
131: Sleeve threaded tube
132: Transfer nut
133: Transfer screw
134: Transfer screw support portion
135: Transfer screw rotor
136: Transfer bar
137: Cable
138: Tube
139: Coupling shaft
141: Lifting screw
142: Cable
143: Tube
144: Knob
146: Adjustment nut
160: Vibration plate
161: Massage pad engaging groove
162: Threadedly engaging groove
163: Elongated hole
165: Engaging groove
170: Support member
171: Fastening screw
171a: Screw head
172: Support rubber
173: Rubber washer

1. A topical massage device comprising:
a base plate (12);
a plurality of support members (170) engaged to an upper portion of the base plate (12), and made of an elastic material;
a vibration plate (160) fixed to an upper portion of the respective support members (170);
a massage pad (110) installed to an upper portion of the vibration plate (160) so as to move in forward and rearward directions; and
a vibrator (120) engaged to the vibration plate (160) to vibrate the massage pad (110).

2. The topical massage device according to claim 1, further comprising transfer screw support portions (134) provided to front and rear portions of the vibration plate (160);
a transfer screw (133) rotatably installed to the transfer screw support portions (134) at both ends thereof;
a transfer screw rotor (135) engaged to one end of the transfer screw (133) to rotate the transfer screw (133); and
a transfer bar (136) provided with at a lower portion thereof with a transfer nut (132) which is threadedly engaged to the transfer screw (133), with the massage pad (110) being detachably engaged to an upper portion of the transfer bar, so that a position of the massage pad (110) is adjusted by rotating the transfer screw rotor (135).

3. The topical massage device according to claim 2, wherein the massage pad (110) is formed integrally with the transfer bar (136).

4. The topical massage device according to claim 1, wherein two transfer screws (133) are installed to front and rear portions of the vibration plate (160), and both ends of the respective transfer screws are supported by the transfer screw support portions (134) so as to rotate independently;
a transfer screw rotor (135) is provided to one end of the respective transfer screws (133) to rotate the transfer screw (133);
the massage pad (110) includes an anterior massage member (111) and a posterior massage member (112) which are separated from each other; and
a bottom surface of the anterior massage member (111) and a bottom surface of the posterior massage member (112) are provided with transfer nuts (132) which are threadedly engaged to the transfer screws (133).

5. The topical massage device according to claim 1, wherein two transfer screws (133) are installed to front and rear portions of the vibration plate (160), and both ends of the respective transfer screws are supported by the transfer screw support portions (134) so as to rotate independently;
a transfer screw rotor (135) is provided to one end of the respective transfer screws (133) to rotate the transfer screw (133);
the massage pad (110) includes an anterior massage member (111) with a nut (111a) provided on a bottom surface thereof and a posterior massage member (112) with a nut (112a) provided on a bottom surface thereof, with the anterior massage member and the posterior massage member being separately provided;
the anterior massage member (111) and the posterior massage member (112) are engaged to an upper portion of a transfer bar (136) with a transfer screw support portion (134) formed at one side thereof; and
lifting screws (141) pass rotatably through the respective transfer bars (136), and are engaged to the nuts (111a and 112a), respectively.

6. The topical massage device according to claim 1, wherein transfer screws (133) are installed to front and rear portions of the vibration plate (160), and one end of the transfer screw (133) has a transfer bar (136);
the massage pad (110) includes an anterior massage member (111) with a nut (111a) provided on a bottom surface thereof and a posterior massage member (112) with a nut (112a) provided on a bottom surface thereof, with the anterior massage member and the posterior massage member being separately provided;
lifting screws (141) pass rotatably through the respective transfer bars (136), and are engaged to the nuts (111a and 112a), respectively; and
an adjustment nut (146) for moving the respective transfer bars (136) in forward and rearward directions is engaged to the transfer screw (133).

7. The topical massage device according to 2, wherein a cable (137) is connected between the transfer screw rotor (135) and the transfer screw (133) in a state in which the cable (137) is enclosed by a protective tube (138), so that a user accurately adjusts a position of the massage pad (110) by remote control.

8. The topical massage device according to claim 1, wherein the massage pad (110) includes an anterior massage member (111) protruding from a front portion of the massage pad in a curved shape to massage a perineal region of a user, and a posterior massage member (112) protruding from a rear portion of the massage pad in a curved shape to massage an anal sphincter.

9. The topical massage device according to claim 1, wherein the support member (170) has a cylindrical support rubber (172) with upper and lower portions engaged to fastening screws (171) to transmit soft vibration to the massage pad (110), and
the fastening screw (171) has a screw head (171a) formed on one end of the fastening screw, and a recessed portion (171b) formed on an engaging surface of the screw head (171a), thereby increasing an engaging force between the upper and lower fastening screws (171) and the support rubber (172).

10. The topical massage device according to claim 1, wherein the massage pad (110) includes an anterior massage member (111) and a posterior massage member (112) which are separated from each other;
a transfer nut (132) is provided to a bottom surface of the anterior massage member (111), and a transfer nut (132) is provided to a bottom surface of the posterior massage member (112);
one transfer nut (132) is threadedly engaged to a hollow sleeve threaded tube (131);
the other transfer nut (132) is threadedly engaged to a transfer screw (133) which is provided to one end of a coupling shaft (139) which is positioned in the sleeve threaded tube (131) and is able to freely rotate therein; and
a transfer screw rotor (135) is provided to the other end of the coupling shaft (139) and one side of the sleeve threaded tube (131) to separately rotate the coupling shaft and the sleeve threaded tube.

11. The topical massage device according to claim 4, wherein the bottom surface of the anterior massage member (111) is provided with a nut (111a), and the bottom surface of the posterior massage member (112) is provided with a nut (112a);
the anterior and posterior massage members (111 and 112) are coupled to an upper portion of a transfer bar (136) provided with a transfer nut (132), respectively; and
a lifting screw (141) is rotatably installed to the respective transfer bars (136), and is engaged to the respective nuts (111a and 112a), so that the anterior and posterior massage members (111 and 112) are independently moved up and down by rotation of the lifting screws (141).

12. A chair (1) equipped with a topical massage device, wherein the topical massage device (100) set forth in claim 1 is installed to a center portion of a seating unit (20) of the chair (1), and
an upper plate of the seating unit (20) supports hips of a user, and a massage pad (110) which comes into direct contact with a topical region protrudes upwardly from the seating unit (20).

13. A seating mat (200) equipped with a topical massage device, wherein the topical massage device (100) set forth in claim 1 is installed to a center portion of the seating mat (200), and
an upper plate of the seating mat supports hips of a user, and a massage pad (110) which comes into direct contact with a topical region protrudes upwardly from the seating mat.

14. The chair equipped with the topical massage device according to claim 12, wherein a backrest unit (10) is provided to one side of the seating unit (20) to support a back of the user, and
the backrest unit (10) includes an upper body stretching member (50) which has a hand lever (51) operated in a vertical direction by a driving force, so that when the hand lever (51) is moved up by both hands, the user can relief upper muscles and ligaments.

15. The chair equipped with the topical massage device according to claim 14, wherein a lower portion of the backrest unit (10) is provided with an actuator (79) and a lumbar stretching member (70) having a lumbar supporter (72) connected to the actuator (79) to be moved up and down by the actuator, so that when the lumbar supporter (72) moves forward, a lumbar vertebra of the user is pressed.
